(19) United States
(12) Patent Application Publication
(10) Pub. No.: US 2026/0172949 A1
(43) Pub. Date: Jun. 18, 2026

(54) SYSTEM AND METHOD FOR WIRELESS COMMUNICATIONS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/421,323

(22) Filed: Dec. 16, 2025

Related U.S. Application Data
(60) Provisional application No. 63/734,254, filed on Dec. 16, 2024.
(60) Provisional application No. 63/776,623, filed on Mar. 24, 2025.

(51) Int. Cl. H04W 48/12; H04W 88/10

(52) U.S. Cl. CPC H04W 48/12; H04W 88/10

(57) ABSTRACT

Embodiments of a method and apparatus for wireless communications are disclosed. In an embodiment, a wireless device includes a controller configured to generate a beacon frame, which contains an Ultra High Reliability (UHR) Basic Service Set (BSS) parameter change count (BPCC), and a wireless transceiver configured to announce the beacon frame.

### CROSS-REFERENCE TO RELATED APPLICATIONS

This application is entitled to the benefit of U.S. Provisional Patent Application Ser. No. 63/734,254, filed on Dec. 16, 2024 and U.S. Provisional Patent Application Ser. No. 63/776,623, filed on Mar. 24, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to generate a beacon frame, which contains an Ultra High Reliability (UHR) Basic Service Set (BSS) parameter change count (BPCC), and a wireless transceiver configured to announce the beacon frame. Other embodiments are also disclosed.

In an embodiment, the UHR BPCC is defined for counting UHR critical events.

In an embodiment, when an UHR critical update of an access point (AP) occurs, the UHR BPCC of the AP is increased by one.

In an embodiment, when an UHR critical update of an access point (AP) multi-link device (MLD) occurs, the UHR BPCC of each AP affiliated with the AP MLD is increased by one.

In an embodiment, the beacon frame includes a basic multi-link element, which includes a common information (Info) field that carries the UHR BPCC of a reporting access point (AP).

In an embodiment, a Presence Bitmap field carries an indication regarding whether the UHR BPCC of the reporting AP is carried in the beacon frame.

In an embodiment, the beacon frame includes a basic multi-link element, which includes a station (STA) information (Info) field that carries the UHR BPCC of a reported access point (AP).

In an embodiment, the STA Info field carries an indication regarding whether the UHR BPCC of the reported AP is carried in the beacon frame.

In an embodiment, the beacon frame includes an indication in a Capability Information And Status Indication field regarding whether an UHR critical update is carried in the beacon frame.

In an embodiment, the Capability Information And Status Indication field includes an UHR critical update flag and a full critical update being carried flag.

In an embodiment, an UHR critical update is carried in the beacon frame when the UHR critical update flag is set to 1 and the full critical update being carried flag is set to 1.

In an embodiment, a critical update of a reporting access point (AP) is carried in a respective element of a critical update in the beacon frame.

In an embodiment, a critical update of a reported access point (AP) is carried in a respective subelement of a critical update in a Per station (STA) Profile of the reported AP.

In an embodiment, the wireless device is compatible with an Institute of Electrical and Electronics Engineers (IEEE) 802.11 protocol.

In an embodiment, a method for wireless communications includes at a wireless device, generating a beacon frame, which contains an Ultra High Reliability (UHR) Basic Service Set (BSS) parameter change count (BPCC) and at the wireless device, announcing the beacon frame.

In an embodiment, the UHR BPCC is defined for counting UHR critical events.

In an embodiment, when an UHR critical update of an access point (AP) occurs, the UHR BPCC of the AP is increased by one.

In an embodiment, when an UHR critical update of an access point (AP) multi-link device (MLD) occurs, the UHR BPCC of each AP affiliated with the AP MLD is increased by one.

In an embodiment, the beacon frame includes a basic multi-link element, which includes a common information (Info) field that carries the UHR BPCC of a reporting access point (AP).

In an embodiment, a Presence Bitmap field carries an indication regarding whether the UHR BPCC of the reporting AP is carried in the beacon frame.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 depicts a new defined element format carrying an UHR BPCC in accordance with example embodiments.

FIG. 5 depicts a beacon format that contains the new defined element format depicted in FIG. 4 in accordance with example embodiments.

FIG. 6 depicts a current defined element format carrying an UHR BPCC in accordance with example embodiments.

FIG. 7 depicts a multi-link control field in accordance with example embodiments.

FIG. 8 depicts a presence bitmap subfield in accordance with example embodiments.

FIG. 9 depicts a common info field in accordance with example embodiments.

FIG. 10 depicts a beacon format that contains a basic multi-link element 1050 in accordance with example embodiments.

FIG. 11 depicts a basic multi-link element format carrying an UHR BPCC in accordance with example embodiments.

FIG. 12 depicts a multi-link control field in accordance with example embodiments.

FIG. 13 depicts a presence bitmap subfield that carries UHR BPCC information in accordance with example embodiments.

FIG. 14 depicts a presence bitmap subfield that carries UHR BPCC information in accordance with example embodiments.

FIG. 15 depicts an Extended MLD Capabilities and Operations Present that carries UHR BPCC information in accordance with example embodiments.

FIG. 16 depicts a beacon format that contains an element carrying an UHR BPCC in accordance with example embodiments.

FIG. 17 depicts a capability information and status indication field in accordance with example embodiments.

FIG. 18 depicts a new defined element format carrying an UHR BPCC and an UHR critical update in accordance with example embodiments.

FIG. 19 depicts a beacon format that contains the new defined element format depicted in FIG. 18 in accordance with example embodiments.

FIG. 20 depicts a Basic Multi-Link element format carrying an UHR BPCC and an UHR critical update in accordance with example embodiments.

FIG. 21 depicts a Per-STA (station) Profile Subelement format of the Basic Multi-Link element format depicted in FIG. 20 in accordance with example embodiments.

FIG. 22 depicts a STA Control field format in accordance with example embodiments.

FIG. 23 depicts a STA Info field format in accordance with example embodiments.

FIG. 24 depicts a Target Beacon Transmission Time (TBTT) information field format carrying a Seamless Mobility Domain (SMD) identifier (ID) and UHR BPCC subfield in accordance with example embodiments.

FIG. 25 depicts an MLD parameters subfield in accordance with example embodiments.

FIG. 26 depicts an SMD ID and UHR BPCC subfield in accordance with example embodiments.

FIG. 27 is a process flow diagram of a method for wireless communications in accordance with example embodiments.

FIG. 28 depicts AP MLDs with different links in accordance with example embodiments.

FIG. 29 depicts a configuration of the AP MLDs with the different links depicted in FIG. 28 in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

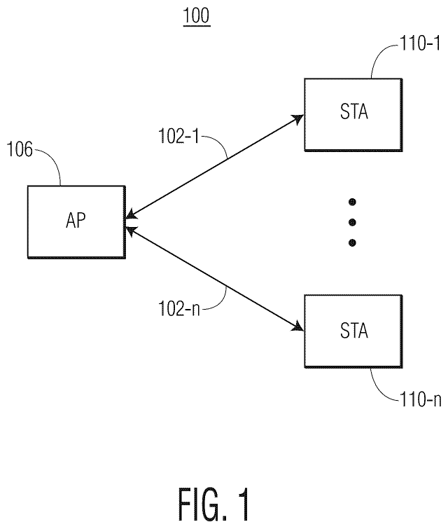

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110- n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 1102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

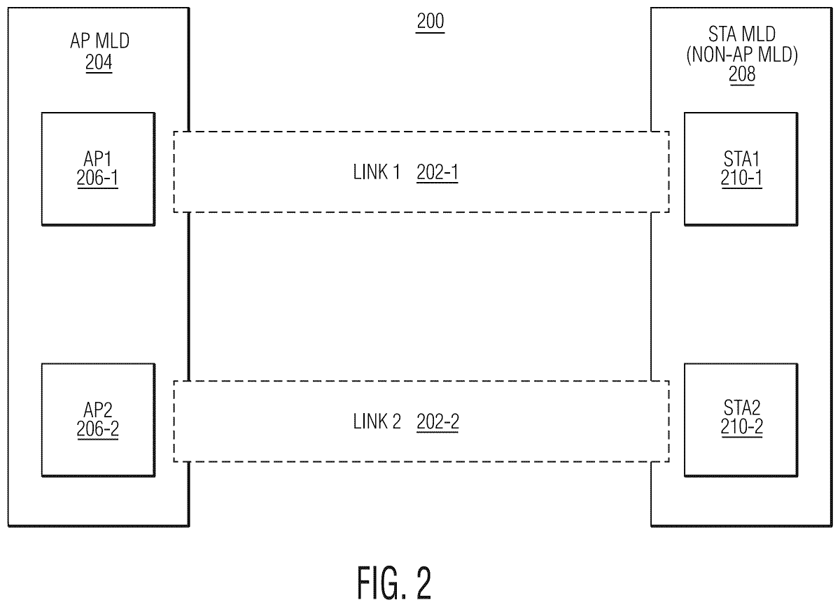

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., data frames, beacon frames and the other management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

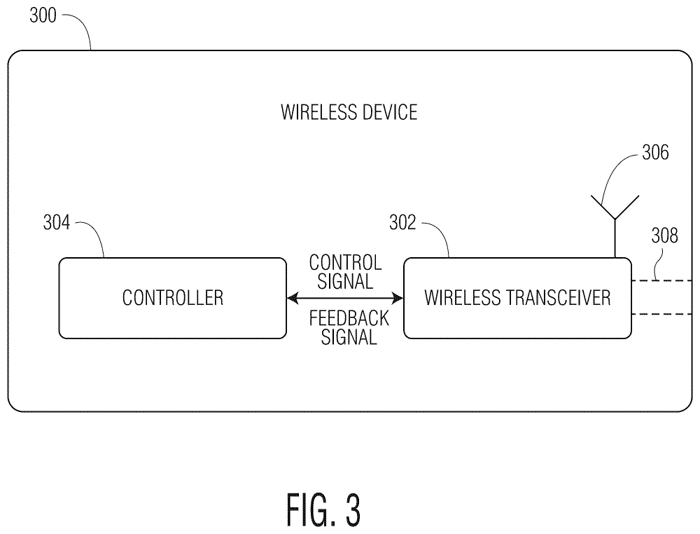

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications (e.g., critical update) information, for example, information related to data, communications links, and/or wireless devices (e.g., operation and/or capability parameters of wireless devices) within the wireless communications system.

In accordance with an embodiment of the disclosure, the controller 304 is configured to generate a beacon frame, which contains an Ultra High Reliability (UHR) BSS parameter change count (BPCC) and which may temporarily contains the critical update of an AP and/or an AP MLD, and the wireless transceiver 302 is configured to announce the beacon frame, for example, through the at least one antenna 306. In some embodiments, the wireless device 300 is an AP in an AP device without the other APs or an AP in a co-hosted AP set, which advertises its capabilities, operation parameters etc. in its own beacon frame. For example, the wireless device 300 does not support a multiple BSSID (MBSSID) feature with which a single AP advertises several SSIDs within one beacon frame. In a MBSSID set, one AP is designated as the transmitted BSSID, which transmits Beacons to carry the information of itself and the non-transmitted BSSID AP(s)while other AP(s) is/are non-transmitted BSSID AP(s) and does/do not transmit Beacons. In some embodiments, an UHR BPCC of a device provides a count to indicate changes in UHR Basic Service Set (BSS) parameters of the device. For example, the UHR BPCC allows a client or a wireless device to efficiently monitor when UHR BSS parameters have been updated by one or more affiliated access points (APs) and/or one or more MLDs of the one or more affiliated APs, ensuring the client or the wireless device has the most current information for each link without needing to parse every change in detail or having to compare all parameters. In some embodiments, a change in the UHR BPCC of a device indicates that at least one UHR parameter has changed in the device and/or an MLD of the device, and a client or a wireless device can investigate further to find the specific changed UHR parameter. In some embodiments, a client or a wireless device can observing an UHR BPCC on one link while entering a low-power state on another link.

In some embodiments, the UHR BPCC is defined for counting UHR critical events. In some embodiments, the UHR BPCC is defined for an UHR critical event of an AP and an AP MLD that the AP is affiliated with. In some embodiments, an UHR critical event is an event in which an UHR critical update in one or more UHR operation parameters of the BSS of an AP and/or an AP MLD that the AP is affiliated occurs.

In some embodiments, when an UHR critical update of an access point (AP) occurs, the UHR BPCC of the AP is increased by one.

In some embodiments, when an UHR critical update of an access point (AP) multi-link device (MLD) occurs, the UHR BPCC of each AP affiliated with the AP MLD is increased by one, and the critical update is temporarily carried in the related element in several Beacons.

In some embodiments, an UHR critical update of an AP or an AP MLD corresponds to a change in one or more UHR operation parameters of the BSS associated with the AP or the AP MLD. For example, the parameter update of AP's NPCA (non-primary channel access) includes NPCA enabling/disabling, NPCA primary channel, switch delay to NPCA primary channel, switch back delay to primary channel, NPCA channel puncture; the parameter update of AP's DSO (dynamic subband operation) includes enabling/disabling; the parameter update of AP's DBE (dynamic bandwidth extension bandwidth) includes DBE bandwidth, channel puncture information. the parameter update of AP's DPS (dynamic power save) includes enabling/disabling, ICF Required, DPS padding delay, DPS transition delay, bandwidth (BW), Number of Spatial Streams (Nss), Modulation Coding Scheme (MCS) in DPS low-capacity (LC) mode; the parameter update of AP's P-EDCA (prioritized enhanced distributed channel access) includes PEDCA CWmin (Contention Window Minimum), PEDCA CWmax (Contention Window Maximum), PEDCA AIFSN (Arbitration Inter-Frame Space Number) etc.

In some embodiments, the beacon frame includes a basic multi-link element, which includes a common information (Info) field that carries the UHR BPCC of a reporting access point (AP). In some embodiments, a Presence Bitmap field carries an indication regarding whether the UHR BPCC of the reporting AP is carried in the beacon frame. In some embodiments, the beacon frame includes a basic multi-link element, which includes a station (STA) information (Info) field that carries the UHR BPCC of a reported access point (AP). In some embodiments, the STA Info field carries an indication regarding whether the UHR BPCC of the reported AP is carried in the beacon frame. In some embodiments, the beacon frame includes an indication in a Capability Information And Status Indication field regarding whether an UHR critical update is carried in the beacon frame. In some embodiments, the Capability Information And Status Indication field includes an UHR critical update flag and a full critical update being carried flag. In some embodiments, an UHR critical update is carried in the beacon frame when the UHR critical update flag is set to 1 and the full critical update being carried flag is set to 1. In some embodiments, a critical update of a reporting access point (AP) is carried in a respective element of a critical update in the beacon frame. In some embodiments, a critical update of a device (e.g., an AP) includes at least one of the parameter update of DSO, NPCA, DPS, P-EDCA, DBE, AP's Periodic Unavailability Operation (PUO), dynamic unavailability operation (DUO). In some embodiments, a critical update of a reported access point (AP) is carried in a respective subelement of a critical update in a Per station (STA) Profile of the reported AP.

In some embodiments, a new field of the common Info field carries the UHR BPCC.

In some embodiments, the beacon frame includes an UHR multi-link element, which includes a common information (Info) field that carries the UHR BPCC.

In some embodiments, the beacon frame includes a basic multi-link element, which includes a Per Link information (Info) field that carries the UHR BPCC of a reported AP.

In some embodiments, the beacon frame includes a basic multi-link element, which includes a presence bitmap subfield or an extended MLD capabilities and operations subfield that carries the UHR BPCC of a reported AP.

In some embodiments, the beacon frame includes an UHR critical update flag and a full critical update being carried flag.

In some embodiments, an UHR critical update is carried in the beacon frame if the UHR critical update flag is set to 1 and the full critical update being carried flag is set to 1. In some embodiments, the UHR critical update related to the reporting AP is carried in several Beacons temporarily, e.g., the related element of the critical update. In some embodiments, the UHR critical update related to the reported AP is carried in several Beacons temporarily, e.g., the related subelement of the critical update in Per STA Profile of the reported AP.

In some embodiments, the wireless device 300 is compatible with an Institute of Electrical and Electronics Engineers (IEEE) 802.11 protocol.

In some embodiments, the wireless device 300 is associated with a wireless multi-link device (MLD), and the wireless transceiver 302 is further configured to conduct frame exchanges with a second wireless MLD through wireless links between the wireless MLD and the second wireless MLD.

As described with examples, the relationship between the Critical Update Flag and a new indication of the critical update is clarified. In addition, an Ultra High Reliability (UHR) Basic Service Set (BSS) parameter change count (BPCC) is defined and the relationship between UHR BPCC and BPCC is clarified. Further, an AP's behavior when critical update related UHR features occur or happen is clarified.

Some implementations for UHR BSS Parameter Change Count (BPCC) versus BPCC, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, an UHR BPCC is defined for an UHR critical event. In some embodiments, when an UHR critical update of an AP happens or occurs, the UHR BPCC of the AP is increased by one. In some embodiments, when an UHR critical update of an AP MLD happens or occurs, the UHR BPCC of each AP affiliated with the AP MLD is increased by one.

In some embodiments, each beacon of an AP (e.g., a reporting AP) carries the AP's UHR BPCC (BSS parameters change count).

In some embodiments, an UHR BPCC is independent from a BPCC. In some embodiments, in Option 1, the UHR BPCC of the reporting AP is carried in a new defined element, e.g., in the Common Information (Info) field of an UHR Multi-Link element. In some embodiments, in Option 2, the UHR BPCC of the reporting AP is carried in a current defined element, e.g., in the Common Info field of a Basic Multi-Link element.

Some examples of a reported AP's BPCC is described. In some embodiments, in Option 1, in AP1's Beacon, AP2's UHR BPCC is not carried. In some embodiments, in Option 2, in AP1's Beacon, AP2's UHR BPCC is carried. In some embodiments, in Option 2.1, a UHR Multi-Link element is defined where the Common Info field carries the UHR BPCC of the reporting AP, each Per Link Info, e.g., the STA Info of Per Link Info, carries the UHR BPCC of a reported AP. In some embodiments, in Option 2.2, in a Basic Multi-Link element, the Per Link Info field carries the UHR BPCC of a reported AP.

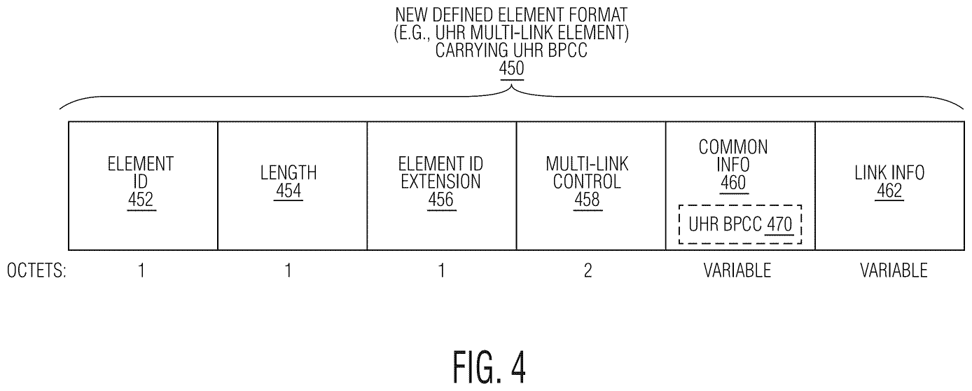

FIG. 4 depicts a new defined element format (e.g., an UHR Multi-Link element) 450 carrying an UHR BPCC 470 in accordance with example embodiments. In the embodiment depicted in FIG. 4, the new defined element format 450 includes an element identification (ID) field 452 (e.g., one-octet) that may contain identification information regarding which specific element this element represents, an element length field 454 (e.g., one-octet) that may contain element length information, an element ID extension field 456 (e.g., one-octet) that may contain ID extension information, a multi-link control field 458 (e.g., two-octet) that may contain multi-link control information, a common info field 460 (e.g., variable length) that may contain common information, and a link info field 462 (e.g., variable length) that may contain link information. In some embodiments, the common info field 460 contains the UHR BPCC 470.

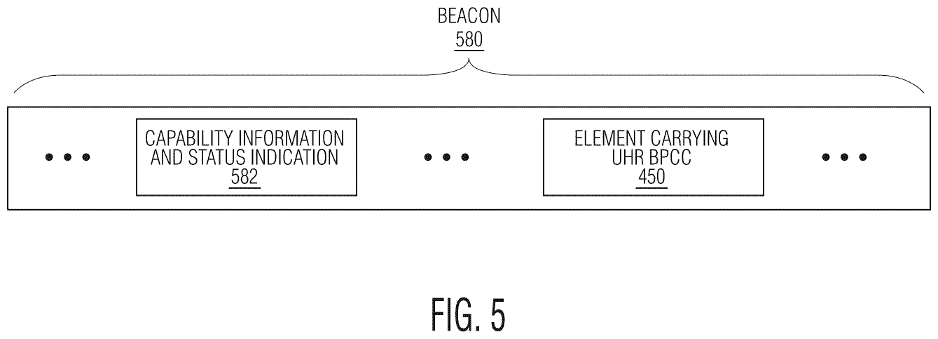

FIG. 5 depicts a beacon format 580 that contains the new defined element format 450 depicted in FIG. 4 in accordance with example embodiments. In the embodiment depicted in FIG. 5, the beacon format 580 includes the new defined element format 450 carrying the UHR BPCC 470 and capability information and status indication 582.

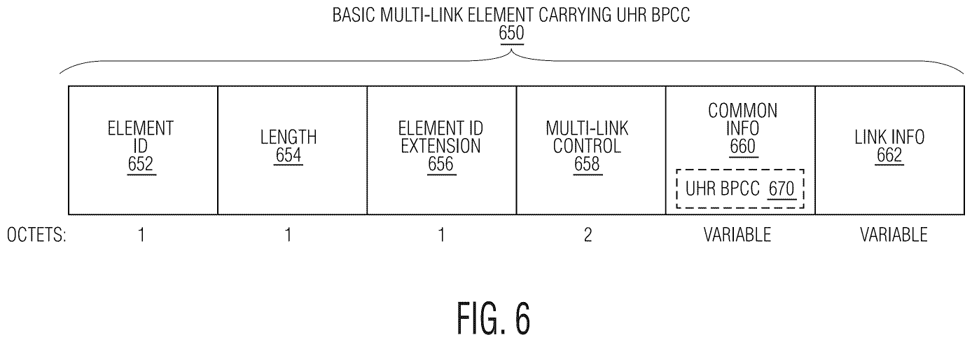

FIG. 6 depicts a current defined element format (e.g., a Basic Multi-Link element) 650 carrying an UHR BPCC 670 in accordance with example embodiments. In the embodiment depicted in FIG. 6, the current defined element format 650 includes an element identification (ID) field 652 (e.g., one-octet) that may contain identification information regarding which specific element this element represents, an element length field 654 (e.g., one-octet) that may contain element length information, an element ID extension field 656 (e.g., one-octet) that may contain ID extension information, a multi-link control field 658 (e.g., two-octet) that may contain multi-link control information, a common info field 660 (e.g., variable length) that may contain common information, and a link info field 662 (e.g., variable length) that may contain link information. In some embodiments, the common info field 660 contains the UHR BPCC 670.

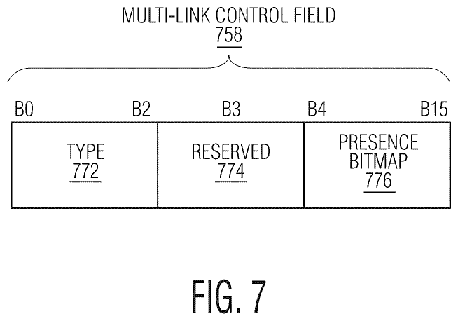

FIG. 7 depicts a multi-link control field 758 in accordance with example embodiments. The multi-link control field 758 depicted in FIG. 7 is one possible embodiment of the multi-link control field 658 depicted in FIG. 6. In the embodiment depicted in FIG. 7, the multi-link control field 758 includes a type subfield 772 (e.g., three-bit) that may contain type information, a reserved subfield 774 (e.g., three-bit) that may contain reserved information, and a presence bitmap subfield 776 (e.g., twelve-bit) that may contain presence bitmap information.

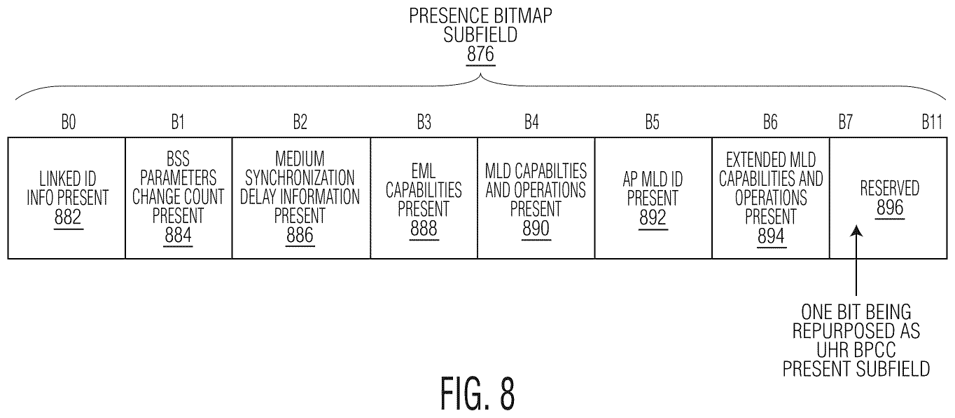

FIG. 8 depicts a presence bitmap subfield 876 in accordance with example embodiments. The presence bitmap subfield 876 depicted in FIG. 8 is one possible embodiment of the presence bitmap subfield 776 depicted in FIG. 7. In the embodiment depicted in FIG. 8, the presence bitmap subfield 876 includes a link ID info present field 882 (e.g., one-bit) that may contain link ID information present information, a BSS Parameters Change Count present field 884 (e.g., one-bit) that may contain BSS Parameters Change Count present information, a Medium Synchronization Delay Information present field 886 (e.g., one-bit) that may contain Medium Synchronization Delay Information present information, an Enhanced Multi-Link (EML) Capabilities Present field 888 (e.g., one-bit) that may contain EML Capabilities Present information, an MLD Capabilities and Operations Present field 890 (e.g., one-bit) that may contain MLD Capabilities and Operations Present information, an AP MLD ID Present field 892 (e.g., one-bit) that may contain AP MLD ID Present information, an Extended MLD Capabilities and Operations Present 894 (e.g., one-bit) that may contain Extended MLD Capabilities and Operations Present information, and a reserved field 896 (e.g., five-bit) that may contain reserved information. In some embodiments, one bit of the reserved field 896 is repurposed as an UHR BPCC Present subfield.

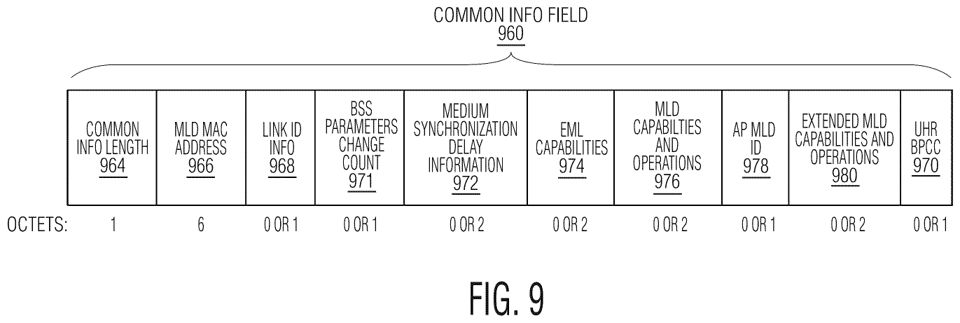

FIG. 9 depicts a common info field 960 in accordance with example embodiments. The common info field 960 depicted in FIG. 9 is one possible embodiment of the common info field 660 depicted in FIG. 6. In the embodiment depicted in FIG. 9, the common info field 960 includes a common info length subfield 964 (e.g., one-octet) that may contain common info length information, an MLD MAC address subfield 966 (e.g., six-octet) that may contain MLD MAC address information, a link ID info subfield 968 (e.g., zero or one octet) that may contain link ID information, a BSS parameters change count subfield 971 (e.g., zero or one octet) that may contain BSS parameters change count information, a medium synchronization delay information subfield 972 (e.g., zero or two octets) that may contain medium synchronization delay information, an EML capabilities subfield 974 (e.g., zero or two octets) that may contain EML capabilities information, an MLD Capabilities and Operations field 976 (e.g., zero or two octets) that may contain MLD Capabilities and Operations information, an AP MLD ID field 978 (e.g., zero or one octet) that may contain AP MLD ID information, an Extended MLD Capabilities and Operations Present 980 (e.g., zero or two octets) that may contain Extended MLD Capabilities and Operations information, and an UHR BPCC field 970 (e.g., zero, i.e., without UHR BPCC field or one octet, i.e., with UHR BPCC field being carried) that may contain UHR BPCC information. In some embodiments, if/when the UHR BPCC Present subfield has the value 1, the UHR BPCC field is present to carry the UHR BPCC value.

Some implementations for UHR BPCC of Reporting AP, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, in Option 1 of UHR BPCC location, an UHR BPCC is carried in a new added field of a Common Info field. For example, the UHR BPCC field 982 depicted in FIG. 9 is carried in a new field of the common info field 960 depicted in FIG. 9.

In some embodiments, in Option 2 of UHR BPCC location, an UHR BPCC is carried in a Presence Bitmap Subfield.

In some embodiments, in Option 3 of UHR BPCC location, an UHR BPCC is carried in an Extended MLD Capabilities And Operations subfield of a Basic Multi-Link element.

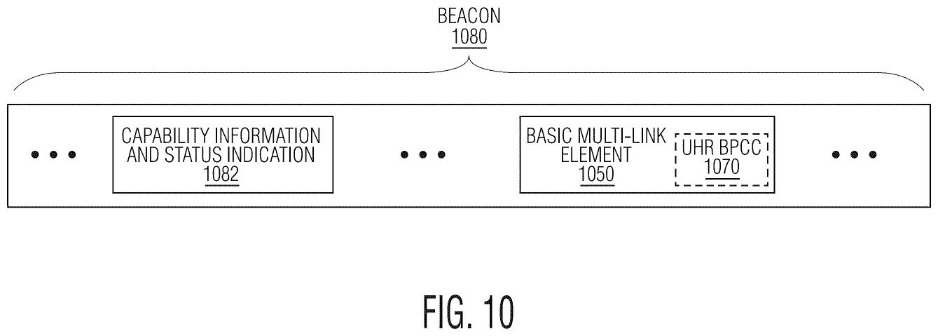

FIG. 10 depicts a beacon format 1080 that contains a basic multi-link element 1050 in accordance with example embodiments. In the embodiment depicted in FIG. 10, the beacon format 1080 includes the basic multi-link element 1050 carrying an UHR BPCC 1070 and capability information and status indication 1082.

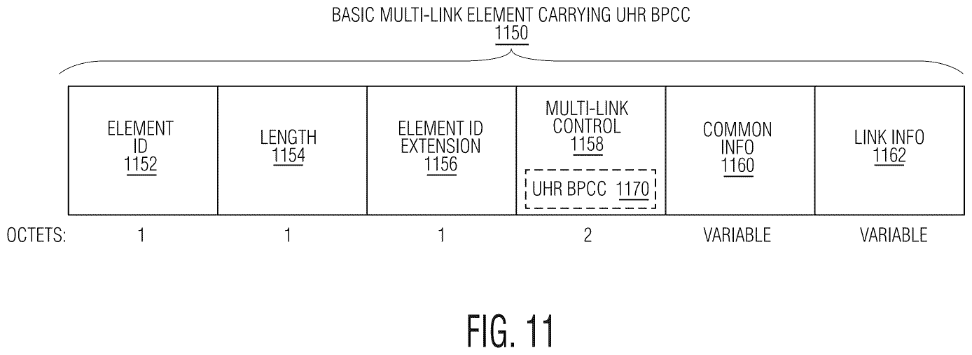

FIG. 11 depicts a basic multi-link element format 1150 carrying an UHR BPCC 1170 in accordance with example embodiments. In the embodiment depicted in FIG. 11, the basic multi-link element format 1150 includes an element identification (ID) field 1152 (e.g., one-octet) that may contain identification information regarding which specific element this element represents, an element length field 1154 (e.g., one-octet) that may contain element length information, an element ID extension field 1156 (e.g., one-octet) that may contain ID extension information, a multi-link control field 1158 (e.g., two-octet) that may contain multi-link control information, a common info field 1160 (e.g., variable length) that may contain common information, and a link info field 1162 (e.g., variable length) that may contain link information. In some embodiments, the multi-link control field 1158 contains the UHR BPCC 1170.

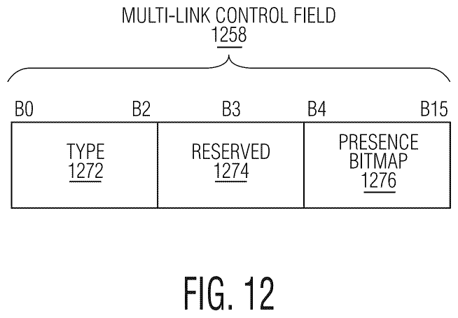

FIG. 12 depicts a multi-link control field 1258 in accordance with example embodiments. The multi-link control field 1258 depicted in FIG. 12 is one possible embodiment of the multi-link control field 1158 depicted in FIG. 11. In the embodiment depicted in FIG. 12, the multi-link control field 1258 includes a type subfield 1272 (e.g., three-bit) that may contain type information, a reserved subfield 1274 (e.g., three-bit) that may contain reserved information, and a presence bitmap subfield 1276 (e.g., twelve-bit or other suitable length) that may contain presence bitmap information.

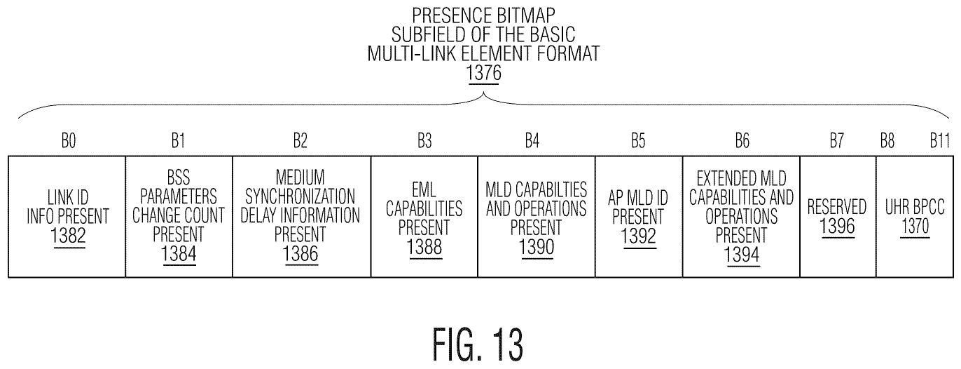

FIG. 13 depicts a presence bitmap subfield 1376 that carries UHR BPCC information in accordance with example embodiments. The presence bitmap subfield 1376 depicted in FIG. 13 is one possible embodiment of the presence bitmap subfield 1276 depicted in FIG. 12. In the embodiment depicted in FIG. 13, the presence bitmap subfield 1376 includes a link ID info present field 1382 (e.g., one-bit) that may contain link ID information present information, a BSS Parameters Change Count present field 1384 (e.g., one-bit) that may contain BSS Parameters Change Count present information, a Medium Synchronization Delay Information present field 1386 (e.g., one-bit) that may contain Medium Synchronization Delay Information present information, an Enhanced Multi-Link (EML) Capabilities Present field 1388 (e.g., one-bit) that may contain EML Capabilities Present information, an MLD Capabilities and Operations Present field 1390 (e.g., one-bit) that may contain MLD Capabilities and Operations Present information, an AP MLD ID Present field 1392 (e.g., one-bit) that may contain AP MLD ID Present information, an Extended MLD Capabilities and Operations Present 1394 (e.g., one-bit) that may contain Extended MLD Capabilities and Operations Present information, a reserved field 1396 (e.g., one-bit) that may contain reserved information, and an UHR BPCC subfield 1370 (e.g., four-bit) that may contain UHR BPCC information.

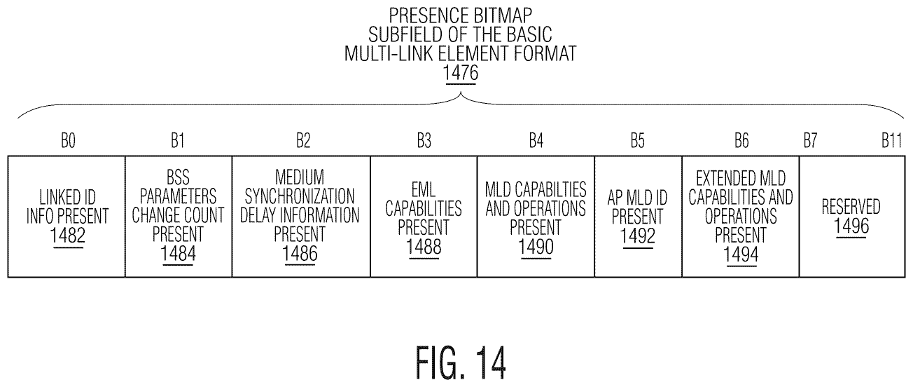

FIG. 14 depicts a presence bitmap subfield 1476 that carries UHR BPCC information in accordance with example embodiments. The presence bitmap subfield 1476 depicted in FIG. 14 is one possible embodiment of the presence bitmap subfield 1276 depicted in FIG. 12. In the embodiment depicted in FIG. 14, the presence bitmap subfield 1476 includes a link ID info present field 1482 (e.g., one-bit) that may contain link ID information present information, a BSS Parameters Change Count present field 1484 (e.g., one-bit) that may contain BSS Parameters Change Count present information, a Medium Synchronization Delay Information present field 1486 (e.g., one-bit) that may contain Medium Synchronization Delay Information present information, an Enhanced Multi-Link (EML) Capabilities Present field 1488 (e.g., one-bit) that may contain EML Capabilities Present information, an MLD Capabilities and Operations Present field 1490 (e.g., one-bit) that may contain MLD Capabilities and Operations Present information, an AP MLD ID Present field 1492 (e.g., one-bit) that may contain AP MLD ID Present information, an Extended MLD Capabilities and Operations Present 1494 (e.g., one-bit) that may contain Extended MLD Capabilities and Operations Present information. In some embodiments, a reserved field 1496 in the Extended MLD Capabilities and Operations is repurposed to contain the UHR BPCC information.

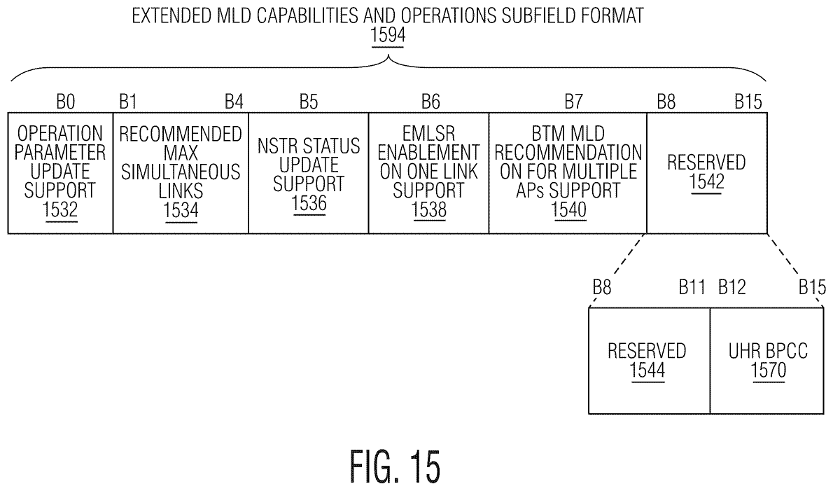

FIG. 15 depicts an Extended MLD Capabilities and Operations Present 1594 that carries UHR BPCC information in accordance with example embodiments. The Extended MLD Capabilities and Operations Present 1594 is one possible embodiment of the Extended MLD Capabilities and Operations Present 1494 in FIG. 14. In the embodiment depicted in FIG. 15, the Extended MLD Capabilities and Operations Present 1594 includes an operation parameter update support field 1532 (e.g., one-bit) that may contain operation parameter update support information, a recommended Maximum (Max) Simultaneous Links field 1534 (e.g., one-bit) that may contain recommended Max Simultaneous Links information, a Non-Simultaneous Transmit and Receive (NSTR) status update support field 1536 (e.g., one-bit) that may contain NSTR status update support information, an Enhanced Multi-Link Single Radio (EMLSR) Enablement on One Link support field 1538 (e.g., one-bit) that may contain EMLSR Enablement on One Link support information, a BSS transition management (BTM) MLD Recommendation For Multiple APs Support field 1540 (e.g., one-bit) that may contain BTM MLD Recommendation For Multiple APs Support information, and a reserved field 1542 (e.g., eight-bit) that may contain reserved information. In some embodiments, the reserved field 1542 is repurposed to contain a reserved field 1544 (e.g., four-bit) that may contain reserved information and a UHR BPCC field 1570 (e.g., four-bit) that may contain UHR BPCC information.

Some implementations of UHR Critical Update Flag vs Critical Update Flag, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, a new UHR Critical Update Flag, e.g., the repurposed reserved bit in a Capability Information And Status Indication field, is defined. In some embodiments, when an AP (AP1) has an UHR critical update, the UHR Critical Update Flag is set to 1 in the AP's (AP1's) Beacons related to continuous Beacon intervals where at least one Beacon is a Delivery Traffic Indication Message (DTIM) Beacon. In some embodiments, when AP2 (Reported AP) affiliated with the same AP MLD as AP1 has an UHR critical update, the UHR Critical Update Flag is set to 1 in AP1's (reporting AP's) Beacons related to continuous Beacon intervals where at least one Beacon is a DTIM Beacon.

In some embodiments, the UHR Critical Update Flag is independent from the Critical Update Flag.

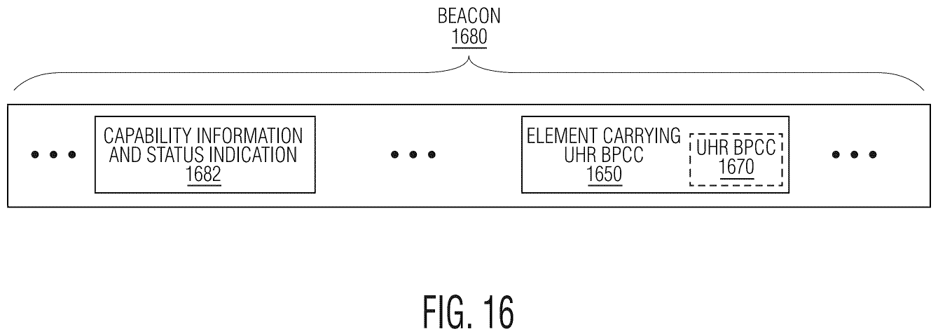

FIG. 16 depicts a beacon format 1680 that contains an element 1650 carrying an UHR BPCC 1670 in accordance with example embodiments. In the embodiment depicted in FIG. 16, the beacon format 1680 includes an element 1650 carrying an UHR BPCC 1670 and capability information and status indication 1682 that carries the UHR Critical Update Flag.

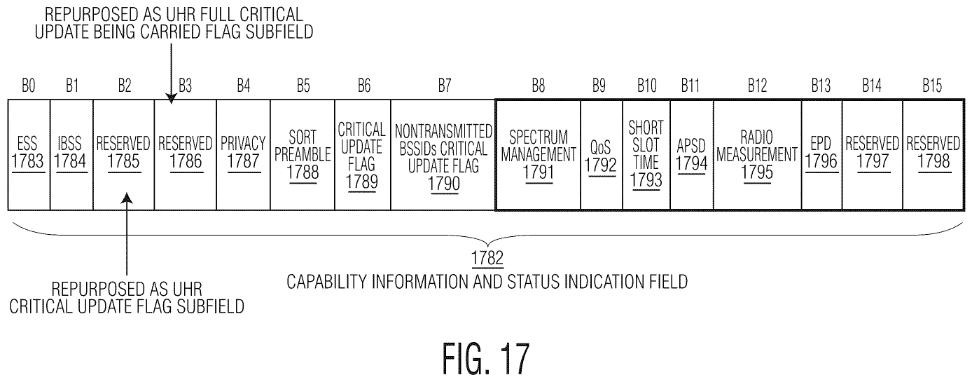

FIG. 17 depicts a capability information and status indication field 1782 in accordance with example embodiments. The capability information and status indication field 1782 depicted in FIG. 17 is one possible embodiment of the capability information and status indication 1682 in FIG. 16. In the embodiment depicted in FIG. 17, the capability information and status indication field 1782 includes an Extended Service Set (ESS) subfield 1783 (e.g., one-bit) that may contain ESS information, an Independent Basic Service Set (IBSS) subfield 1784 (e.g., one-bit) that may contain IBSS information, a reserved subfield 1785 (e.g., one-bit) that may contain reserved information, which can be repurposed as an UHR Critical Update Flag subfield, a reserved subfield 1786 (e.g., one-bit) that may contain reserved information, which can be repurposed as an UHR Full Critical Update Being Carried Flag subfield, a privacy subfield 1787 (e.g., one-bit) that may contain privacy information, a short preamble subfield 1788 (e.g., one-bit) that may contain short preamble information, a critical update flag subfield 1789 (e.g., one-bit) that may contain critical update flag information, a nontransmitted Basic Service Set Identifiers (BSSIDs) critical update flag subfield 1790 (e.g., one-bit) that may contain nontransmitted BSSIDs critical update flag information, a spectrum management subfield 1791 (e.g., one-bit) that may contain spectrum management information, a quality of service (QoS) subfield 1792 (e.g., one-bit) that may contain QoS information, a short slot time subfield 1793 (e.g., one-bit) that may contain short slot time information, an Automatic Power Save Delivery (APSD) subfield 1794 (e.g., one-bit) that may contain APSD information, a radio management subfield 1795 (e.g., one-bit) that may contain radio management information, an EtherType protocol discrimination (EPD) subfield 1796 (e.g., one-bit) that may contain EPD information, a reserved subfield 1797 (e.g., one-bit) that may contain reserved information, and a reserved subfield 1798 (e.g., one-bit) that may contain reserved information.

Some implementations of UHR Full Critical Update Being Carried Flag, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, an UHR Full Critical Update Being Carried Flag, e.g., the repurposed reserved bit in the Capability Information And Status Indication field, is carried in a Beacon of an UHR AP.

In some embodiments, when all the critical update(s) related to an UHR BPCC is carried in a Beacon, the Full Critical Update Being Carried Flag is set to 1 and UHR Critical Update Flag is set to 1.

Some implementations of Transmission of UHR Critical Update, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

Case 1 is about reporting AP's UHR critical update or AP MLD's UHR update:

In some embodiments, in method 1, the UHR critical update related to AP1 or AP MLD is carried in AP1's Beacon if the UHR Critical Update Flag in AP1's Beacon is set to 1 and the Full Critical Update Being Carried Flag in such Beacon is set to 1.

In some embodiments, in method 2, the UHR critical update related to AP1 or AP MLD is not carried in AP1's Beacon when the UHR Critical Update Flag in AP1's Beacon is set to 1. In some embodiments, the Full Critical Update Being Carried Flag in such Beacon is set to 0. In some embodiments, AP1 transmits a broadcast (ML) Probe Response without soliciting or per the soliciting by an ML Probe Request. In some embodiments, the UHR critical update related to AP1 or AP MLD is carried. In some embodiments, the Full Critical Update Being Carried Flag in such Beacon is set to 1. In some embodiments, the broadcast Probe Response may be transmitted several times.

Case 2 is about a reported AP's critical update:

In some embodiments, in Option 1, the UHR critical update related to AP2 is not carried in AP1's Beacon when AP1's UHR Critical Update Flag is set to 1. In some embodiments, the Full Critical Update Being Carried Flag in such Beacon is set to 0. In some embodiments, AP1 transmits a broadcast ML Probe Response without soliciting or per the soliciting by an ML Probe Request. In some embodiments, the UHR critical update related to AP2 is carried. In some embodiments, the Full Critical Update Being Carried Flag in an ML Probe Response is set to 1. In some embodiments, the broadcast Probe Response may be transmitted multiple times.

In some embodiments, in Option 2, the UHR critical update related to AP2 is carried in AP1's Beacon when the UHR Critical Update Flag is set to 1 and the Full Critical Update Being Carried Flag in AP1's Beacon is set to 1. In some embodiments, AP1 transmits a broadcast ML Probe Response without soliciting or per the soliciting by an ML Probe Request. In some embodiments, the UHR critical update related to AP2 is carried. In some embodiments, the Full Critical Update Being Carried Flag in an ML Probe Response is set to 1. In some embodiments, the broadcast Probe Response may be transmitted multiple times.

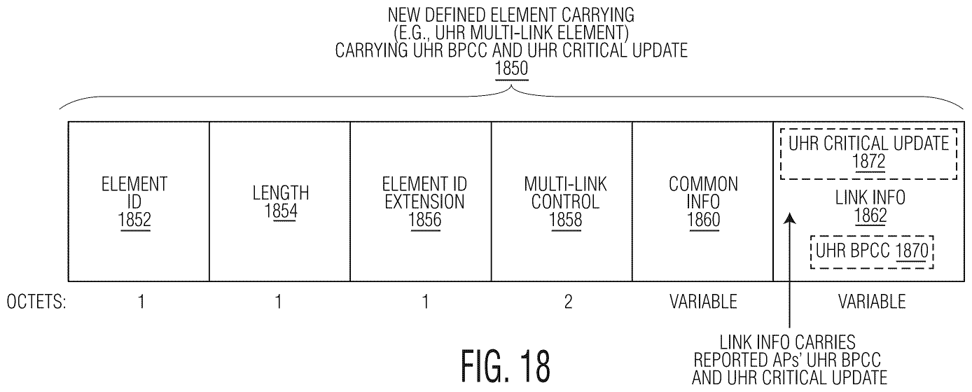

FIG. 18 depicts a new defined element format (e.g., an UHR Multi-Link element) 1850 carrying an UHR BPCC 1870 and an UHR critical update 1872 in accordance with example embodiments. In the embodiment depicted in FIG. 18, the new defined element format 1850 includes an element identification (ID) field 1852 (e.g., one-octet) that may contain identification information regarding which specific element this element represents, an element length field 1854 (e.g., one-octet) that may contain element length information, an element ID extension field 1856 (e.g., one-octet) that may contain ID extension information, a multi-link control field 1858 (e.g., two-octet) that may contain multi-link control information, a common info field 1860 (e.g., variable length) that may contain common information with the UHR BPCC for the reporting AP, and a link info field 1862 (e.g., variable length) that may contain link information. In some embodiments, the link info field 1862 contains the UHR BPCC 1870 and the UHR critical update 1872 as the subelement for the reported AP.

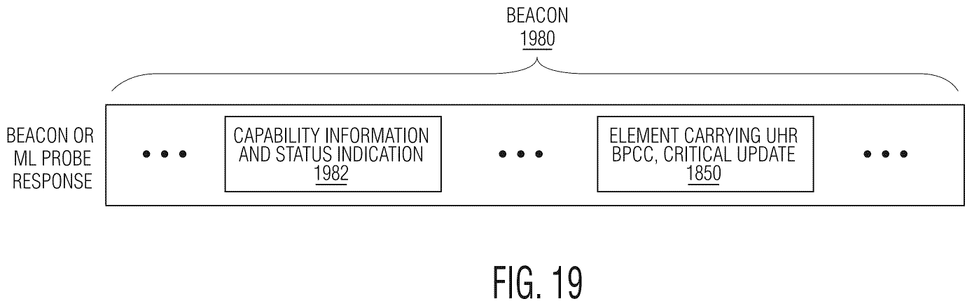

FIG. 19 depicts a beacon format 1980 that contains the new defined element format 1850 depicted in FIG. 18 in accordance with example embodiments. In the embodiment depicted in FIG. 19, the beacon format 1980 includes the new defined element format 1850 and capability information and status indication 1982. In some embodiments, an UHR critical update for the reporting AP is carried in the respective element in the Beacon.

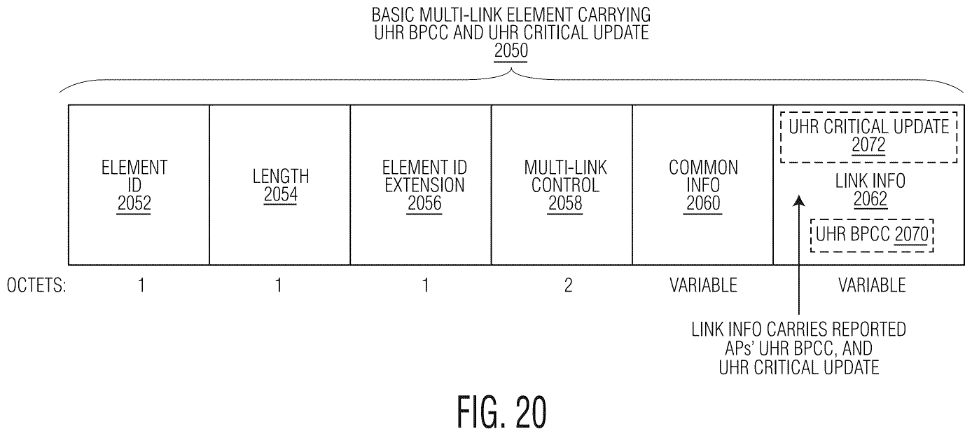

FIG. 20 depicts a Basic Multi-Link element format 2050 carrying an UHR BPCC 2070 and an UHR critical update 2072 in accordance with example embodiments. In the embodiment depicted in FIG. 20, the Basic Multi-Link element format 2050 includes an element identification (ID) field 2052 (e.g., one-octet) that may contain identification information regarding which specific element this element represents, an element length field 2054 (e.g., one-octet) that may contain element length information, an element ID extension field 2056 (e.g., one-octet) that may contain ID extension information, a multi-link control field 2058 (e.g., two-octet) that may contain multi-link control information, a common info field 2060 (e.g., variable length) that may contain common information with the UHR BPCC for the reporting AP, and a link info field 2062 (e.g., variable length) that may contain link information. In some embodiments, the link info field 2062 contains the UHR BPCC 2070 and the UHR critical update 2072 as the subelement for the reported AP.

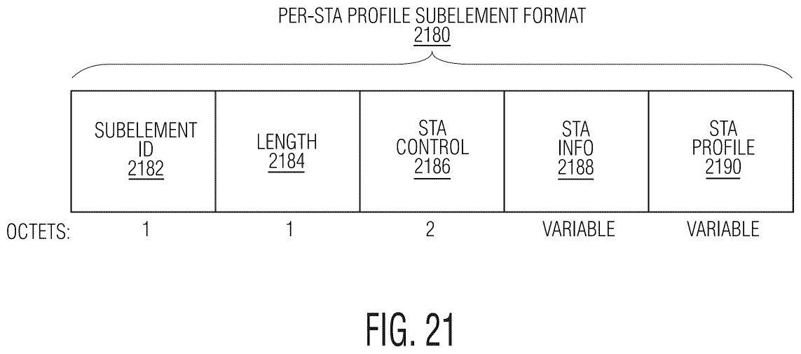

FIG. 21 depicts a Per-STA Profile Subelement format 2180 of the Basic Multi-Link element format 2050 depicted in FIG. 20 in accordance with example embodiments. In the embodiment depicted in FIG. 21, the Per-STA Profile Subelement format 2180 includes a subelement ID field 2182 (e.g., one-octet) that may contain subelement ID information, a length field 2184 (e.g., one-octet) that may contain length information, a STA control field 2186 (e.g., two-octet) that may contain STA control information, a STA Info field 2188 (e.g., variable length) that may contain STA information, and a STA profile field 2190 (e.g., variable length) that may contain STA profile information.

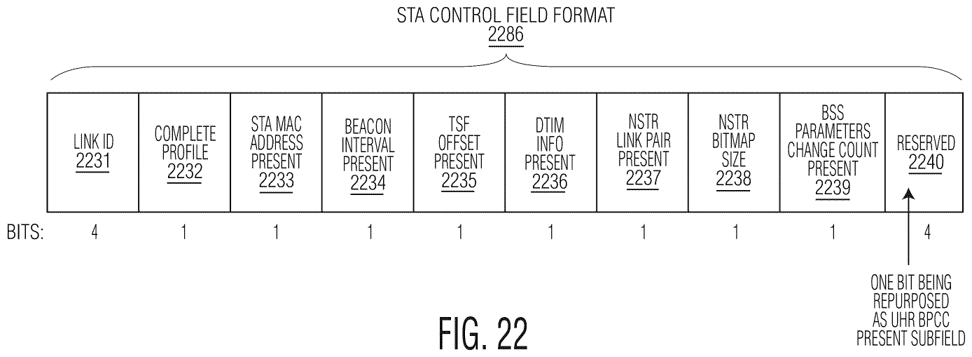

FIG. 22 depicts a STA Control field format 2286 in accordance with example embodiments. In the embodiment depicted in FIG. 22, the STA Control field format 2286 includes a link ID field 2231 (e.g., four-bit) that may contain link ID information, a complete profile field 2232 (e.g., one-bit) that may contain complete profile information, a STA MAC Address Present field 2233 (e.g., one-bit) that may contain STA MAC Address Present information, a Beacon Interval Present field 2234 (e.g., one-bit) that may contain Beacon Interval Present information, a Timing Synchronization Function (TSF) offset present field 2235 (e.g., one-bit) that may contain TSF offset present information, a DTIM info present field 2236 (e.g., one-bit) that may contain DTIM info present information, a Non-Simultaneous Transmit and Receive (NSTR) link pair present field 2237 (e.g., one-bit) that may contain NSTR link pair present information an NSTR bitmap size field 2238 (e.g., one-bit) that may contain NSTR bitmap size information, a BSS parameters change count present field 2239 (e.g., one-bit) that may contain BSS parameters change count present information, and a reserved field 2240 (e.g., four-bit) that may contain reserved information. In some embodiments, one bit of the reserved field 2240 is repurposed as an UHR BPCC Present subfield.

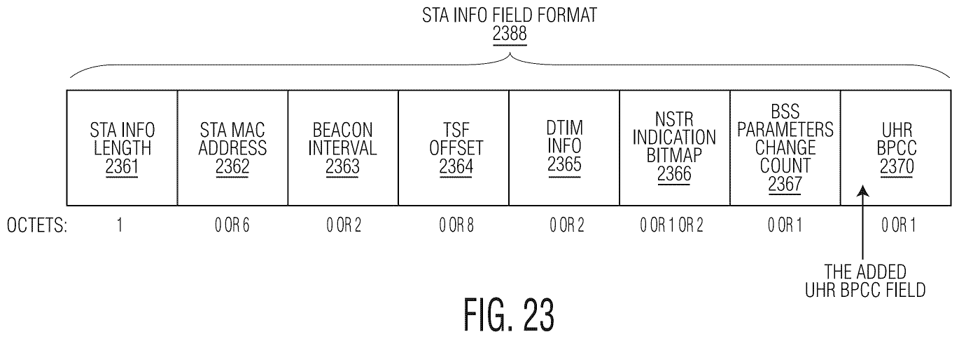

FIG. 23 depicts a STA Info field format 2388 in accordance with example embodiments. In the embodiment depicted in FIG. 23, the STA Info field format 2388 includes a STA info length field 2361 (e.g., one-octet) that may contain STA info length information, a STA MAC Address field 2362 (e.g., zero or six-octet) that may contain STA MAC Address information, a Beacon Interval field 2363 (e.g., zero or two-octet) that may contain Beacon Interval information, a TSF offset field 2364 (e.g., zero or eight-octet) that may contain TSF offset information, a DTIM info field 2365 (e.g., zero or two-octet) that may contain DTIM info information, an NSTR indication bitmap field 2366 (e.g., zero, one-octet, or two-octet) that may contain NSTR indication bitmap information, a BSS parameters change count field 2367 (e.g., zero or one-octet) that may contain BSS parameters change count information, and an UHR BPCC field 2370 (e.g., zero or one-octet) that may contain UHR BPCC information.

Some implementations of UHR BPCC of Reported AP and Reported AP MLD, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, in AP1's Beacon where AP1 and AP2 belong to the same AP MLD, AP2's UHR BPCC is carried.

In some embodiments, Reduced Neighbor Report (RNR) is updated to carry the reported AP's UHR BPCC.

In some embodiments, TBTT Information Length is set to 17.

In some embodiments, SMD ID And UHR BPCC field is carried after MLD Parameters field. In some embodiments, in Option 1, if/when the TBTT (Target Beacon Transmission Time) Information carries the information of the candidate target AP MLD, 4-bit SMD ID is the identifier of the SMD that the target AP MLD belongs to. In some embodiments, if/when the TBTT Information carries the information of the reported AP, 4-bit UHR BPCC is the UHR BPCC of the reported AP. In some embodiments, in Option 2, if/when the TBTT Information carries the information of the candidate target AP MLD, SMD ID And UHR BPCC field is the identifier of the SMD that the target AP MLD belongs to. In some embodiments, if/when the TBTT Information carries the information of the reported AP, SMD ID And UHR BPCC field is the UHR BPCC of the reported AP.

Some implementations of Non-AP MLD's Behavior, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, a non-AP MLD records the UHR BPCC of the AP of the associated AP MLD in each setup link.

In some embodiments, if/when a STA of the non-AP MLD in link 1 receives AP1's Beacon with 1) UHR Critical Update Flag being equal to 1, 2) UHR BPCC being larger than the UHR BPCC that the STA stored, and 3) Full Critical Update Being Carried Flag subfield equal to 1, the STA acquires the UHR critical update in the Beacon and stores the UHR BPCC in the Beacon.

In some embodiments, if/when a STA of the non-AP MLD in link 1 receives AP1's Beacon with 1) UHR Critical Update Flag being equal to 1, 2) UHR BPCC being same as the UHR BPCC that the STA stored, and 3) Full Critical Update Being Carried Flag subfield equal to 0, the STA on behalf of the other STAs affiliated with the same non-AP MLD as the STA acquires the UHR critical update through receiving the ML Probe Response or transmitting Probe Request to soliciting ML Probe Response.

In some embodiments, if/when a STA of the non-AP MLD in link 1 receives AP1's Beacon with 1) UHR Critical Update Flag being equal to 1, 2) UHR BPCC being larger than the UHR BPCC that the STA stored, and 3) Full Critical Update Being Carried Flag subfield equal to 0, the STA acquires the UHR critical update of multiple APs that includes the reporting AP through receiving the ML Probe Response or transmitting Probe Request to soliciting ML Probe Response.

Some implementations of Extreme Low Power Non-AP MLD, for example, performed by the wireless communications system 100 depicted in FIG. 1, the AP/STA of the multi-link (ML) communications system 200 in a link depicted in FIG. 2, and/or the wireless device 300 depicted in FIG. 3 are described.

In some embodiments, when an extreme low power non-AP MLD wakes up in a link, the non-AP MLD needs to receive the Beacon in the link before executing the frame exchanges with the AP MLD in the link.

In some embodiments, if/when the UHR BPCC of the AP in the link is higher than the non-AP MLD's stored UHR BPCC in the link, the non-AP MLD acquires the critical update of the link through the probing procedure.

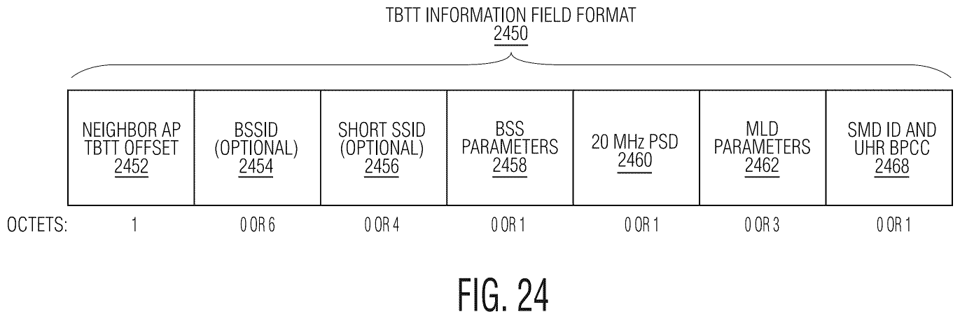

FIG. 24 depicts a TBTT information field format 2450 carrying an SMD ID And UHR BPCC subfield 2468 in accordance with example embodiments. In the embodiment depicted in FIG. 24, the TBTT information field format 2450 includes a neighbor AP TBTT Offset subfield 2452 (e.g., one-octet) that may contain neighbor AP TBTT Offset information, an optional BSSID subfield 2454 (e.g., zero or six-octet) that may contain BSSID information, am optional short SSID subfield 2456 (e.g., zero or four-octet) that may contain short SSID information, a BSS parameters subfield 2458 (e.g., zero or one-octet) that may contain BSS parameters information, a 20 MHz Power Save Delivery (PSD) subfield 2460 (e.g., zero or one-octet) that may contain 20 MHz PSD information, an MLD parameters subfield 2462 (e.g., zero or three-octet) that may contain MLD parameters information, and the SMD ID And UHR BPCC subfield 2468 (e.g., zero or one-octet) that may contain SMD ID And UHR BPCC information.

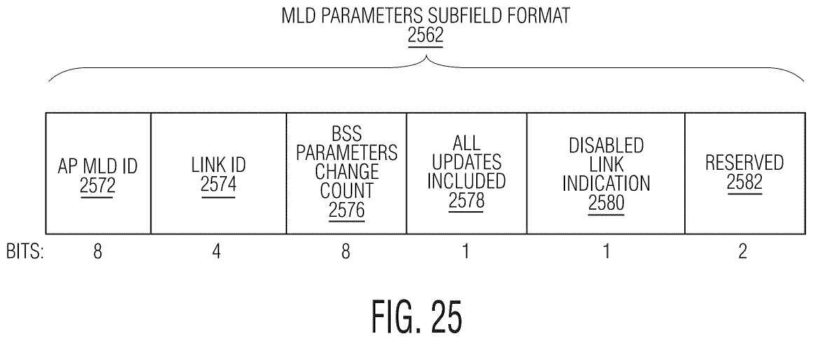

FIG. 25 depicts an MLD parameters subfield 2562 in accordance with example embodiments. In the embodiment depicted in FIG. 25, the MLD parameters subfield 2562 includes an AP MLD ID field 2572 (e.g., eight-bit) that may contain AP MLD ID information, a Link ID field 2574 (e.g., four-bit) that may contain Link ID information, a BSS parameters change count field 2576 (e.g., eight-bit) that may contain BSS parameters change count information, an all updated included field 2578 (e.g., one-bit) that may contain all updated included information, a disabled link indication field 2580 (e.g., one-bit) that may contain disabled link indication information, and a reserved field 2582 (e.g., two-bit) that may contain reserved information.

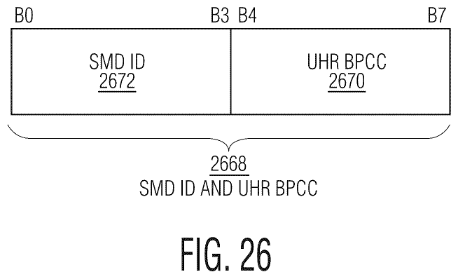

FIG. 26 depicts an SMD ID And UHR BPCC subfield 2668 in accordance with example embodiments. In the embodiment depicted in FIG. 26, the SMD ID And UHR BPCC subfield 2668 includes an SMD ID field 2672 (e.g., four-bit) that may contain SMD ID information and an UHR BPCC field 2670 (e.g., four-bit) that may contain UHR BPCC information.

In some embodiments, a method of notifying its critical update by the first link device affiliated with the first device to the second link devices with each second link device affiliated with a second device includes announcing, by the first link device, the UHR BPCC, UHR Critical update flag, UHR Full Critical Update Being Carried Flag in the Beacon and Recording, by the second device, its UHR BPCC of each link, and acquiring the new UHR critical update if a link's UHR BPCC announced by the first device through first link device is larger than its recorded UHR BPCC of the link. In some embodiments, if in a Beacon frame of a link, the Full Critical Update Being Carried Flag is equal to 1 and UHR Critical update flag is equal to 1, the Beacon frame carries the UHR critical update indicated by the UHR BPCC. In some embodiments, if in a Beacon frame of a link, the Full Critical Update Being Carried Flag is equal to 0 and UHR Critical update flag is equal to 1, the Beacon frame does not carry the UHR critical update indicated by the UHR BPCC. In some embodiments, the second link device solicits the UHR critical update if its recorded UHR BPCC is less than the Beacon's BPCC, and no unsolicited ML Probe Response with the UHR critical update is received. In some embodiments, the UHR BPCC, UHR Critical update flag are independent from BPCC and Critical Update flag respectively. In some embodiments, the UHR Critical update flag, Full Critical Update Being Carried Flag are carried in the Capability Information And Status Indication field. In some embodiments, after waking up in a link, an extreme low-power second device check UHR BPCC of the link and the UHR critical update if exists before doing the frame exchanges in the link.

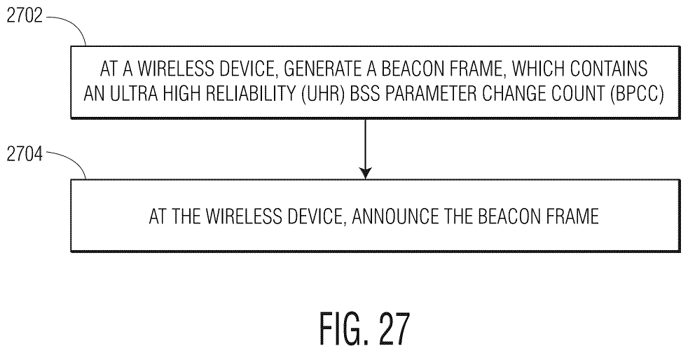

FIG. 27 is a process flow diagram of a method for wireless communications in accordance with example embodiments. At block 2702, at a wireless device, a beacon frame, which contains an Ultra High Reliability (UHR) BSS parameter change count (BPCC), is generated. At block 2704, at the wireless device, the beacon frame is announced. In some embodiments, the wireless device is compatible with an Institute of Electrical and Electronics Engineers (IEEE) 802.11 protocol. In some embodiments, the UHR BPCC is defined for counting UHR critical events. In some embodiments, when an UHR critical update of an access point (AP) occurs, the UHR BPCC of the AP is increased by one. In some embodiments, when an UHR critical update of an access point (AP) multi-link device (MLD) occurs, the UHR BPCC of each AP affiliated with the AP MLD is increased by one. In some embodiments, the beacon frame includes a basic multi-link element, which includes a common information (Info) field that carries the UHR BPCC of a reporting access point (AP). In some embodiments, a Presence Bitmap field carries an indication regarding whether the UHR BPCC of the reporting AP is carried in the beacon frame. The wireless device may be the same as or similar to an embodiment of the AP 106 and/or the STAs 110-1, . . . , 110-n depicted in FIG. 1, the APs 206-1, 206-2 and/or the STAs 210-1, 210-2 depicted in FIG. 2, and/or the wireless device 300 depicted in FIG. 3.

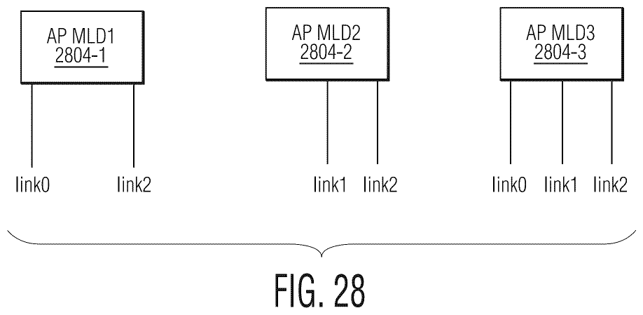

FIG. 28 depicts AP MLDs (AP MLD1 2804-1), (AP MLD2 2804-2), (AP MLD3 2804-3) with different links link0, link1, link2 in accordance with example embodiments. In the embodiment depicted in FIG. 28, the AP MLD1 2804-1 communicates via two communication links, e.g., link0 and link2, the AP MLD2 2804-2 communicates via two communication links, e.g., link1 and link2, and the AP MLD3 2804-3 communicates via three communication links, e.g., link0, link1, link2.

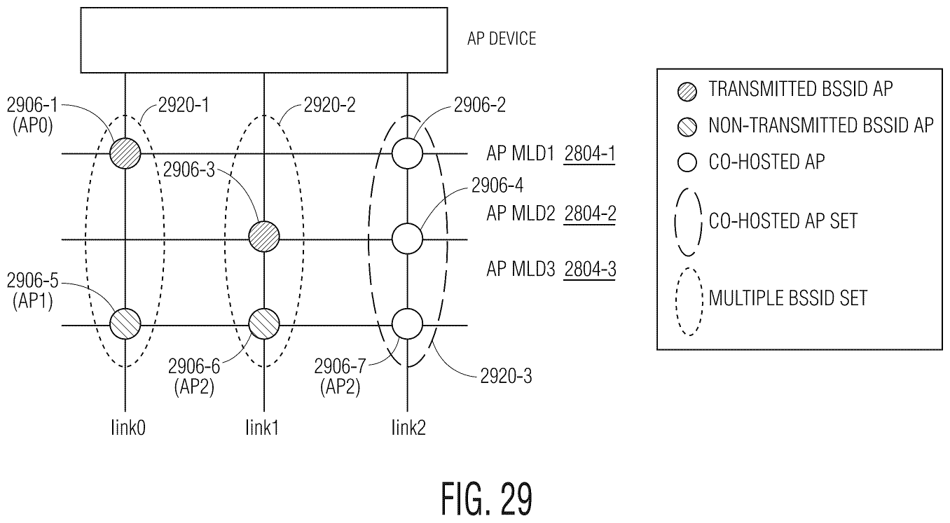

FIG. 29 depicts a configuration of the AP MLDs (the AP MLD1 2804-1, the AP MLD2 2804-2, the AP MLD3 2804-3) with the different links link0, link1, link2 depicted in FIG. 28 in accordance with example embodiments. As depicted in FIG. 29, the AP MLD1 2804-1 includes two APs 2906-1, 2906-2, the AP MLD1 2804-2 includes two APs 2906-3, 2906-4, and the AP MLD1 2804-3 includes three APs 2906-5, 2906-6, 2906-7. The AP 2906-1 of the AP MLD1 2804-1 and the AP 2906-5 of the AP MLD3 2804-3 are both connected to link0 and form a multiple BSSID set 2920-1. In the multiple BSSID set 2920-1, the AP 2906-1 (also designated as AP0) of the AP MLD1 2804-1 acts as a transmitted BSSID AP, while the AP 2906-5 (also designated as AP1) of the AP MLD3 2804-3 acts as a nontransmitted BSSID AP. The AP 2906-3 of the AP MLD2 2804-2 and the AP 2906-6 of the AP MLD3 2804-3 are both connected to link1 and form a multiple BSSID set 2920-2. In the multiple BSSID set 2920-2, the AP 2906-3 of the AP MLD2 2804-2 acts as a transmitted BSSID AP, while the AP 2906-6 of the AP MLD3 2804-3 acts as a nontransmitted BSSID AP. The AP 2906-2 of the AP MLD1 2804-1, the AP 2906-4 of the AP MLD2 2804-2, and the AP 2906-7 of the AP MLD3 2804-3 are connected to link2 and form a co-hosted AP set 2920-3. In the co-hosted AP set 2920-3, the AP 2906-2 of the AP MLD1 2804-1, the AP 2906-4 of the AP MLD2 2804-2, and the AP 2906-7 of the AP MLD3 2804-3 are all co-hosted APs. In some embodiments, in the AP MLD3 2804-3, the AP 2906-5 (also designated as AP1) acts as a reporting AP while the AP 2906-6 and the AP 2906-7 (also designated as AP2) acts as reported APs.

In a co-hosted AP set, each AP advertises its SSID in its own beacon frame, which consumed airtime and increased interference. In a multiple BSSID (MBSSID) set, a single AP advertises several SSIDs within one beacon frame. In a MBSSID set, one SSID is designated as the transmitted BSSID, which is the network name actively broadcast to clients, while other SSID(s) is/are treated as non-transmitted BSSIDs and is/are included in the same beacon frame but not individually broadcasted. By consolidating beacon transmissions, MBSSID can reduce overhead and frees up airtime for actual data communication. MBSSID also lowers the risk of beacon collisions and interference, improving overall network efficiency, which is especially beneficial in environments where multiple virtual networks are needed, such as separating guest access from internal traffic or isolating IoT devices, resulting in a more scalable and responsive wireless infrastructure. In some embodiments, the AP 2906-2 of the AP MLD1 2804-1, the AP 2906-4 of the AP MLD2 2804-2, and/or the AP 2906-7 of the AP MLD3 2804-3 are configured to generate a beacon frame, which contains an Ultra High Reliability (UHR) BSS parameter change count (BPCC), and to announce the beacon frame, for example, through the at least one antenna. In some embodiments, the UHR BPCC is defined for an UHR critical event. In some embodiments, when an UHR critical update of an access point (AP) occurs, the UHR BPCC of the AP is increased by one. In some embodiments, when an UHR critical update of an access point (AP) multi-link device (MLD) occurs, the UHR BPCC of the AP MLD is increased by one. In some embodiments, the beacon frame includes a basic multi-link element, which includes a common information (Info) field that carries the UHR BPCC. In some embodiments, a new field of the common Info field carries the UHR BPCC. In some embodiments, the beacon frame includes an UHR multi-link element, which includes a common information (Info) field that carries the UHR BPCC. In some embodiments, the beacon frame includes a basic multi-link element, which includes a Per Link information (Info) field that carries the UHR BPCC of a reported AP. In some embodiments, the beacon frame includes a basic multi-link element, which includes a presence bitmap subfield or an extended MLD capabilities and operations subfield that carries the UHR BPCC of a reported AP. In some embodiments, the beacon frame includes an UHR critical update flag and a full critical update being carried flag. In some embodiments, an UHR critical update is carried in the beacon frame if the UHR critical update flag is set to 1 and the full critical update being carried flag is set to 1. In some embodiments, the AP 2906-2 of the AP MLD1 2804-1, the AP 2906-4 of the AP MLD2 2804-2, and/or the AP 2906-7 of the AP MLD3 2804-3 are compatible with an Institute of Electrical and Electronics Engineers (IEEE) 802.11 protocol.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to generate a beacon frame, which contains an Ultra High Reliability (UHR) Basic Service Set (BSS) parameter change count (BPCC); and
a wireless transceiver configured to announce the beacon frame.

2. The wireless device of claim 1, wherein the UHR BPCC is defined for counting a plurality of UHR critical events.

3. The wireless device of claim 2, wherein when an UHR critical update of an access point (AP) occurs, the UHR BPCC of the AP is increased by one.

4. The wireless device of claim 2, wherein when an UHR critical update of an access point (AP) multi-link device (MLD) occurs, the UHR BPCC of each AP affiliated with the AP MLD is increased by one.

5. The wireless device of claim 1, wherein the beacon frame comprises a basic multi-link element, which comprises a common information (Info) field that carries the UHR BPCC of a reporting access point (AP).

6. The wireless device of claim 5, wherein a Presence Bitmap field carries an indication regarding whether the UHR BPCC of the reporting AP is carried in the beacon frame.

7. The wireless device of claim 1, wherein the beacon frame comprises a basic multi-link element, which comprises a station (STA) information (Info) field that carries the UHR BPCC of a reported access point (AP).

8. The wireless device of claim 7, wherein the STA Info field carries an indication regarding whether the UHR BPCC of the reported AP is carried in the beacon frame.

9. The wireless device of claim 1, wherein the beacon frame comprises an indication in a Capability Information And Status Indication field regarding whether an UHR critical update is carried in the beacon frame.

10. The wireless device of claim 9, wherein the Capability Information And Status Indication field comprises an UHR critical update flag and a full critical update being carried flag.

11. The wireless device of claim 10, wherein an UHR critical update is carried in the beacon frame when the UHR critical update flag is set to 1 and the full critical update being carried flag is set to 1.

12. The wireless device of claim 9, wherein a critical update of a reporting access point (AP) is carried in a respective element of a critical update in the beacon frame.

13. The wireless device of claim 9, wherein a critical update of a reported access point (AP) is carried in a respective subelement of a critical update in a Per station (STA) Profile of the reported AP.

14. The wireless device of claim 1, wherein the wireless device is compatible with an Institute of Electrical and Electronics Engineers (IEEE) 802.11 protocol.

15. A method for wireless communications, the method comprising:
at a wireless device, generating a beacon frame, which contains an Ultra High Reliability (UHR) Basic Service Set (BSS) parameter change count (BPCC); and
at the wireless device, announcing the beacon frame.

16. The method of claim 15, wherein the UHR BPCC is defined for counting a plurality of UHR critical events.

17. The method of claim 16, wherein when an UHR critical update of an access point (AP) occurs, the UHR BPCC of the AP is increased by one.

18. The method of claim 16, wherein when an UHR critical update of an access point (AP) multi-link device (MLD) occurs, the UHR BPCC of each AP affiliated with the AP MLD is increased by one.

19. The method of claim 15, wherein the beacon frame comprises a basic multi-link element, which comprises a common information (Info) field that carries the UHR BPCC of a reporting access point (AP).

20. The method of claim 19, wherein a Presence Bitmap field carries an indication regarding whether the UHR BPCC of the reporting AP is carried in the beacon frame.
